(19) United States
(12) Patent Application Publication
(10) Pub. No.: US 2008/0023970 A1
(43) Pub. Date: Jan. 31, 2008

(54) Electrical lock device mounting structure

(75) Inventor: Zhi Chung Chang, Taipei Hsien (TW)

Correspondence Address: CHARLES E. BAXLEY, ESQ., 90 JOHN STREET, THIRD FLOOR, NEW YORK, NY, 10038, US

(73) Assignee: Gianni Industries Inc.

(21) Appl. No.: 11/494,011

(22) Filed: Jul. 27, 2006

(51) Int. Cl. E05C 1/02

(52) U.S. Cl. 292/156

(57) ABSTRACT

A lock device includes a mounting plate for attaching to a supporting device and having one or more openings for receiving an electrical cable and having one or more channels each formed by a flange, the flange includes one or more ears, a housing includes one or more orifices for receiving the electrical cable, and one or more grooves each formed by a rib, the rib includes one or more pegs for engaging with the ears of the flange with the pegs of the rib when the mounting plate is moved relative to the housing, and a fastening device may fasten the mounting plate and the housing together to retain the pegs of the rib of the housing in engagement with the ears of the flange of the mounting plate.

### BACKGROUND OF THE INVENTION

1. Field of the Invention

The present invention relates to an electrical lock device, and more particularly to an electrical lock device including an improved mounting structure for allowing the electrical wires or cables to be easily mounted or engaged through the electrical lock device and also for allowing the electrical lock device to be easily and quickly mounted or attached or secured to the supporting structures or members or devices.

2. Description of the Prior Art

Typical electrical lock devices comprise an electromagnetic device and an armature plate or the like to be mounted or attached or secured to the supporting structures or members or devices, such as the door panels, the door frames, the cabinets, the walls or the like, and arranged for allowing the electromagnetic device and the armature plate to be acted or actuated or operated with each other in order to selectively lock the door panels to the door frames, or to selectively release the door panels from the door frames.

The applicant of the present invention has also developed various kinds of typical electrical lock devices that have been allowed and issued. For example, U.S. Pat. No. 6,260,892 to Chang, and U.S. Pat. No. 6,299,225 to Chang disclose two of the typical electrical lock devices each of which also comprise an electromagnetic device and an armature plate for selectively locking the door panels to the door frames, or for selectively releasing the door panels from the door frames.

For energizing or actuating the electromagnetic device, one or more electrical wires or cables are required to be mounted or engaged through the electrical lock device before or when the electrical lock device is mounted or attached or secured to the supporting structures or members or devices.

However, in some circumstances, the electrical wires or cables may be required to be engaged through the supporting structures or members or devices, but the mounting structures of the typical electrical lock devices may not be used to easily engage the electrical wires or cables into the typical electrical lock devices and through the supporting structures or members or devices.

The present invention has arisen to mitigate and/or obviate the afore-described disadvantages of the conventional electrical lock devices.

### SUMMARY OF THE INVENTION

The primary objective of the present invention is to provide an electrical lock device including an improved mounting structure for allowing the electrical wires or cables to be easily mounted or engaged through the electrical lock device and also for allowing the electrical lock device to be easily and quickly mounted or attached or secured to the supporting structures or members or devices.

In accordance with one aspect of the invention, there is provided a lock device comprising a mounting plate for attaching to a supporting device, the mounting plate including one or more openings formed therein for receiving an electrical cable, and including one or more channels formed therein and defined by a flange, the flange including one or more notches or one or more ears formed therein, a housing including one or more orifices formed therein for receiving the electrical cable, and including one or more grooves formed therein and defined by a rib, the rib including one or more pegs or one or more notches formed therein for engaging with the notches or the ears of the flange of the mounting plate respectively and for engaging the pegs into the channels of the mounting plate and for engaging the ears of the flange into the grooves of the housing and for engaging the pegs of the rib with the ears of the flange when the mounting plate is moved relative to the housing, and a fastening device for fastening the mounting plate and the housing together to retain the pegs of the rib of the housing in engagement with the ears of the flange of the mounting plate. The mounting plate may be moved relative to the housing for a relatively small distance or moving stroke to allow the electrical cable to be suitably engaged through the orifices of the housing and the openings of the mounting plate while assembling or coupling the mounting plate and the housing together.

The housing includes one or more passage formed therein, the mounting plate includes one or more screw hole formed therein, and the fastening device includes a fastener engaged through the passage of the housing and engaged with the screw hole of the mounting plate to secure the mounting plate and the housing together.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view illustrating an attachment or a mounting of an electrical lock device in accordance with the present invention to a supporting structure or member or device;

FIG. 2 is a perspective view of the electrical lock device;

FIG. 3 is a partial exploded view of the electrical lock device;

FIG. 4 is another partial exploded view similar to FIG. 3, illustrating the operation of the electrical lock device; and

FIG. 5 is a perspective view similar to FIG. 2, illustrating the mounting or securing or assembling operation of the electrical lock device.

### DETAILED DESCRIPTION OF THE PREFERRED EMBODIMENT

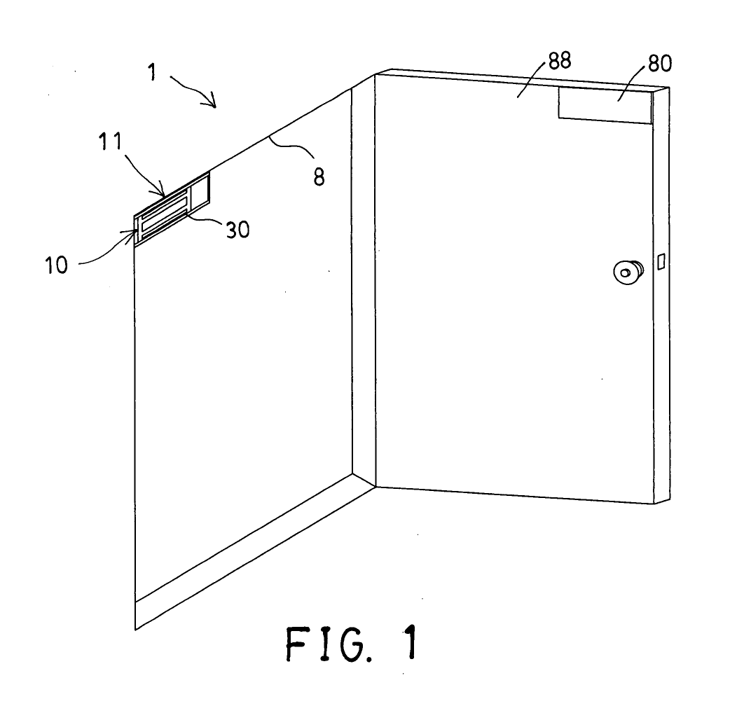

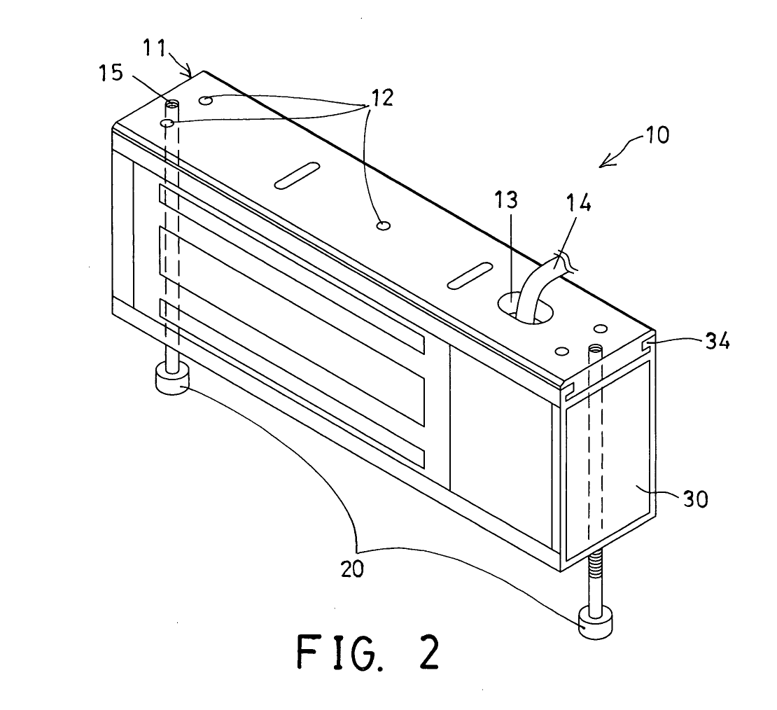

Referring to the drawings, and initially to FIGS. 1 and 2, an electrical lock device 1 in accordance with the present invention comprises an electromagnetic device 10 provided for being mounted or attached or secured to a supporting structure or member or device 8, such as a door panel, a door frame 8, a cabinet, a wall member or the like, for acting or actuating or operating with an electromagnetic plate or armature plate 80 which is provided for being mounted or attached or secured to another supporting structure or member or device 88, such as a door frame, a cabinet, a wall member, a door panel 88, or the like, and arranged for allowing the electromagnetic device 10 and the armature plate 80 to be acted or actuated or operated with each other in order to selectively lock the door panel 88 to the door frame 8, or to selectively release the door panel 88 from the door frame 8.

The electromagnetic device 10 includes a mounting plate 11 having one or more apertures 12 formed therein for receiving latches or fasteners (not shown) which may be used to attach or secure the mounting plate 11 to either of the supporting device 8, 88, and having one or more openings 13 formed therein for receiving one or more electrical wires or cables 14 which may be required to be engaged through the supporting device 8, 88, and having one or more screw holes 15 formed therein for receiving or engaging with a fastening means or device or one or more fasteners 20 which may be used to solidly secure a housing 30 to the mounting plate 11, in which the housing 30 is provided for receiving the typical electromagnetic members (not shown), such as the coils, the plungers, the solenoids or the like. One example of the typical electromagnetic members has been shown and disclosed in the applicant's prior U.S. Pat. No. 6,299,225 to Chang which may be taken as a reference for the present invention.

The mounting plate 11 includes two side channels 16 formed therein and each formed or defined by a flange 17, in which the flange 17 includes one or more notches 18 formed therein for forming or defining one or more ears 19. The housing 30 includes one or more passages 31 formed therein and aligned with the screw holes 15 of the mounting plate 11 for receiving the fasteners 20, and includes one or more orifices 32 formed therein and aligned with the openings 13 of the mounting plate 11 for receiving the electrical wires or cables 14. The housing 30 further includes two side rail ways or grooves 33 formed therein and each formed or defined by a rib 34 for slidably receiving the flanges 17 of the mounting plate 11 respectively, in which the rib 34 of the housing 30 includes one or more notches 35 formed therein for forming or defining one or more keys or pegs 36.

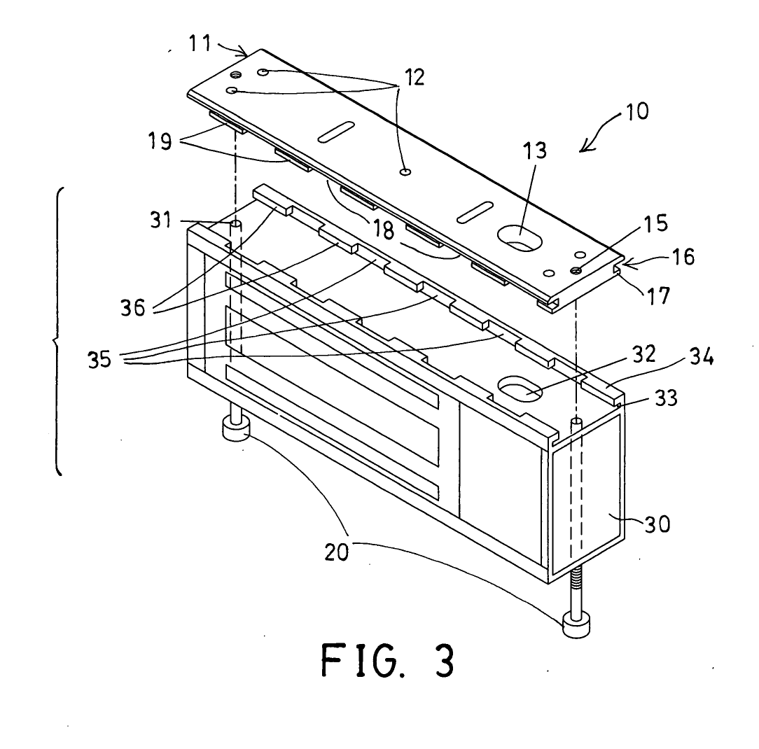

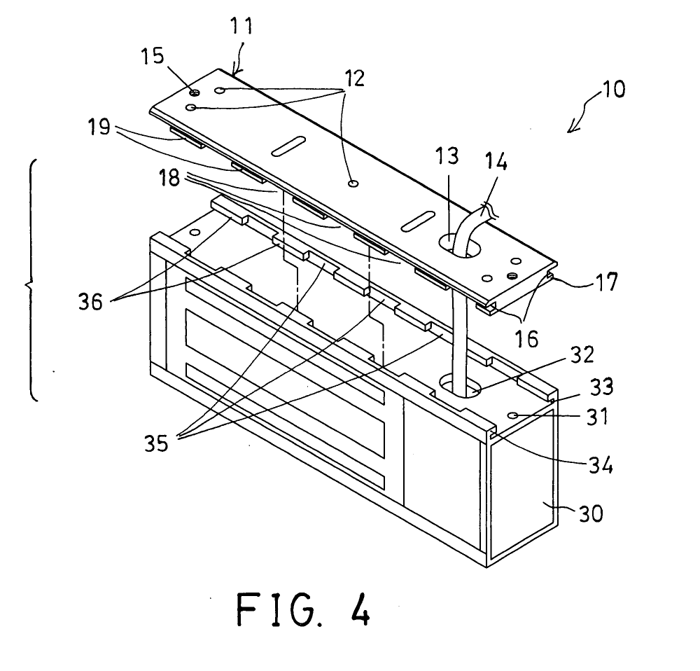

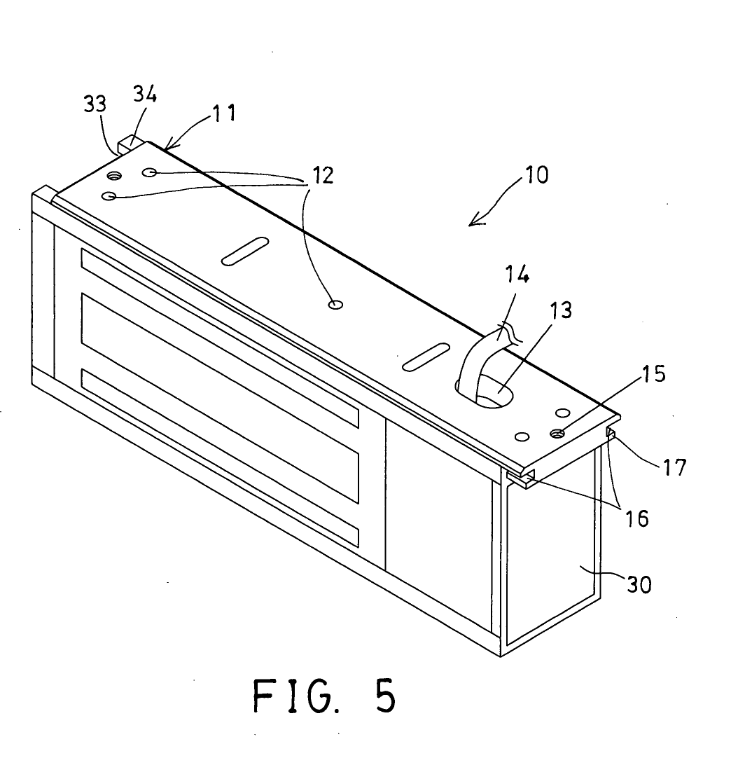

In operation or in assembling the mounting plate 11 and the housing 30, as shown in FIGS. 3-5 and 2, the electrical wires or cables 14 may first be engaged through the orifices 32 of the housing 30 and the openings 13 of the mounting plate 11 before or when the mounting plate 11 and the housing 30 are assembled together. The ears 19 of the mounting plate 11 may then be engaged through the notches 35 of the housing 30 and then engaged into the grooves 33 of the housing 30 respectively in order to engage with the pegs 36 of the housing 30 when the mounting plate 11 is moved longitudinally relative to the housing 30 to allow the mounting plate 11 to be solidly and stably anchored and positioned to the housing 30. The fasteners 20 may then be engaged through the passages 31 of the housing 30 and engaged with the screw holes 15 of the mounting plate 11 for solidly and stably securing and assembling the mounting plate 11 and the housing 30 together.

Similarly or alternatively or relatively, the pegs 36 of the housing 30 may be engaged through the notches 18 of the mounting plate 11 and then engaged into the side channels 16 of the mounting plate 11 respectively in order to engage with the ears 19 of the mounting plate 11 when the mounting plate 11 is moved longitudinally relative to the housing 30 to allow the mounting plate 11 to be solidly and stably anchored and positioned to the housing 30. Similarly, the fasteners 20 may then be engaged through the passages 31 of the housing 30 and engaged with the screw holes 15 of the mounting plate 11 in order to solidly and stably secure and assemble the mounting plate 11 and the housing 30 together and to solidly and stably retain the ears 19 of the mounting plate 11 in engagement with the pegs 36 of the housing 30 and to prevent the ears 19 of the mounting plate 11 from being disengaged from the pegs 36 of the housing 30.

It is to be noted that the mounting plate 11 may first be solidly attached or secured to either of the supporting device 8, 88 with the latches or fasteners (not shown), and the engagement of the pegs 36 of the housing 30 through the notches 18 of the mounting plate 11 and with the ears 19 of the mounting plate 11, and the engagement of the ears 19 of the mounting plate 11 through the notches 35 of the housing 30 and with the pegs 36 of the housing 30 allow the mounting plate 11 to be moved longitudinally relative to the housing 30 for a relatively small distance or moving stroke, and thus allow the electrical wires or cables 14 to be suitably engaged through the orifices 32 of the housing 30 and the openings 13 of the mounting plate 11 while assembling or coupling the mounting plate 11 and the housing 30 together. In addition, the fastening of the mounting plate 11 to the housing 30 with the fasteners 20 allows the pegs 36 of the housing 30 to be solidly engaged with the ears 19 of the mounting plate 11.

Accordingly, the electrical lock device in accordance with the present invention includes an improved mounting structure for allowing the electrical wires or cables to be easily mounted or engaged through the electrical lock device and also for allowing the electrical lock device to be easily and quickly mounted or attached or secured to the supporting structures or members or devices.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A lock device comprising:
a mounting plate for attaching to a supporting device, said mounting plate including at least one opening formed therein for receiving an electrical cable, and including at least one channel formed therein and defined by a flange, said flange including at least one notch formed therein,
a housing including at least one orifice formed therein for receiving the electrical cable, and including at least one groove formed therein and defined by a rib, said rib including at least one peg formed therein for engaging through said at least one notch of said flange of said mounting plate and for engaging into said at least one channel of said mounting plate and for engaging with said flange of said mounting plate when said mounting plate is moved relative to said housing, and
means for fastening said mounting plate and said housing together to retain said at least one peg of said rib of said housing in engagement with said flange of said mounting plate.

2. The lock device as claimed in claim 1, wherein said housing includes at least one passage formed therein, said mounting plate includes at least one screw hole formed therein, and said fastening means includes a fastener engaged through said at least one passage of said housing and engaged with said at least one screw hole of said mounting plate to secure said mounting plate and said housing together.

3. A lock device comprising:
a mounting plate for attaching to a supporting device, said mounting plate including at least one opening formed therein for receiving an electrical cable, and including at least one channel formed therein and defined by a flange, said flange including at least one ear formed therein,
a housing including at least one orifice formed therein for receiving the electrical cable, and including at least one groove formed therein and defined by a rib, said rib including at least one notch formed therein for receiving said at least one ear of said flange of said mounting plate and for allowing said at least one ear of said flange to be engaged into said at least one groove of said housing and for engaging with said rib of said housing when said mounting plate is moved relative to said housing, and
means for fastening said mounting plate and said housing together to retain said at least one ear of said flange of said mounting plate in engagement with said rib of said housing.

4. The lock device as claimed in claim 3, wherein said housing includes at least one passage formed therein, said mounting plate includes at least one screw hole formed therein, and said fastening means includes a fastener engaged through said at least one passage of said housing and engaged with said at least one screw hole of said mounting plate to secure said mounting plate and said housing together.

5. A lock device comprising:
a mounting plate for attaching to a supporting device, said mounting plate including at least one opening formed therein for receiving an electrical cable, and including at least one channel formed therein and defined by a flange, said flange including at least one notch and at least one ear formed therein,
a housing including at least one orifice formed therein for receiving the electrical cable, and including at least one groove formed therein and defined by a rib, said rib including at least one peg and at least one notch formed therein for engaging with said at least one notch and said at least one ear of said flange of said mounting plate respectively and for engaging said at least one peg into said at least one channel of said mounting plate and for engaging said at least one ear of said flange into said at least one groove of said housing and for engaging said at least one peg of said rib with said at least one ear of said flange when said mounting plate is moved relative to said housing, and
means for fastening said mounting plate and said housing together to retain said at least one peg of said rib of said housing in engagement with said at least one ear of said flange of said mounting plate.

6. The lock device as claimed in claim 5, wherein said housing includes at least one passage formed therein, said mounting plate includes at least one screw hole formed therein, and said fastening means includes a fastener engaged through said at least one passage of said housing and engaged with said at least one screw hole of said mounting plate to secure said mounting plate and said housing together.
